(19) United States
(12) Patent Application Publication
(10) Pub. No.: US 2015/0154124 A1
(43) Pub. Date: Jun. 4, 2015

(54) SECURE DATA PARTITION IN NONVOLATILE MEMORY SYSTEMS

(71) Applicant: Intel Corporation, Santa Clara, CA (US)

(72) Inventors: Shamanna Datta, Hillsboro, OR (US); Mark A. Schmisseur, Phoenix, AZ (US); Murugasamy Nachimuthu, Beaverton, OR (US); Richard P. Mangold, Forest Grove, OR (US); Mahesh S. Natu, Sunnyvale, CA (US)

(73) Assignee: Intel Corporation, Santa Clara, CA (US)

(21) Appl. No.: 14/093,772

(22) Filed: Dec. 2, 2013

(51) Int. Cl. G06F 12/14; G06F 11/10

(52) U.S. Cl. CPC G06F 12/1458; G06F 11/1016

(57) ABSTRACT

Apparatus, systems, and methods to implement a secure data partition in memory systems are described. In one example, a controller comprises logic to receive, in a system management mode mailbox, a memory partition creation request from a system management mode interface, wherein the memory partition creation request comprises at least one characteristic of a memory partition, authenticate the partition creation request and create a memory partition in a memory coupled to the controller in accordance with the at least one characteristic. Other examples are also disclosed and claimed.

### FIELD

The present disclosure generally relates to the field of electronics. More particularly, aspects generally relate to apparatus and methods to manage high capacity memory.

### BACKGROUND

Electronic devices such as computers, tablets, mobile phones, electronic readers, and the like comprise components from various manufacturers. It may be useful to permit component providers to define secure partitions in memory to allow for storage of component-specific information such as information manuals, configuration menus, system logs, and the like. Accordingly, techniques to provide secure data partitions in nonvolatile memory systems may find utility, e.g., in memory systems for electronic devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a schematic, block diagram illustration of components of an apparatus in which secure data partitions in nonvolatile memory systems may be implemented in accordance with various examples discussed herein.

FIG. 2 is a schematic block diagram illustrating data flows in an apparatus in which secure data partitions in nonvolatile memory systems may be implemented in accordance with various examples discussed herein

FIGS. 3A-3B and 4A-4B are flowcharts illustrating operations in methods to secure data partitions in nonvolatile memory systems in accordance with various examples discussed herein.

FIGS. 5A-5D are a schematic illustrations of interface calls in an apparatus in which secure data partitions in nonvolatile memory systems may be implemented in accordance with various examples discussed herein.

FIGS. 6-10 are schematic, block diagram illustrations of electronic devices which may be adapted to implement methods to reduce power delivery noise for partial writes in accordance with various examples discussed herein.

### DETAILED DESCRIPTION

In the following description, numerous specific details are set forth in order to provide a thorough understanding of various examples. However, various examples may be practiced without the specific details. In other instances, well-known methods, procedures, components, and circuits have not been described in detail so as not to obscure the particular examples. Further, various aspects of examples may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

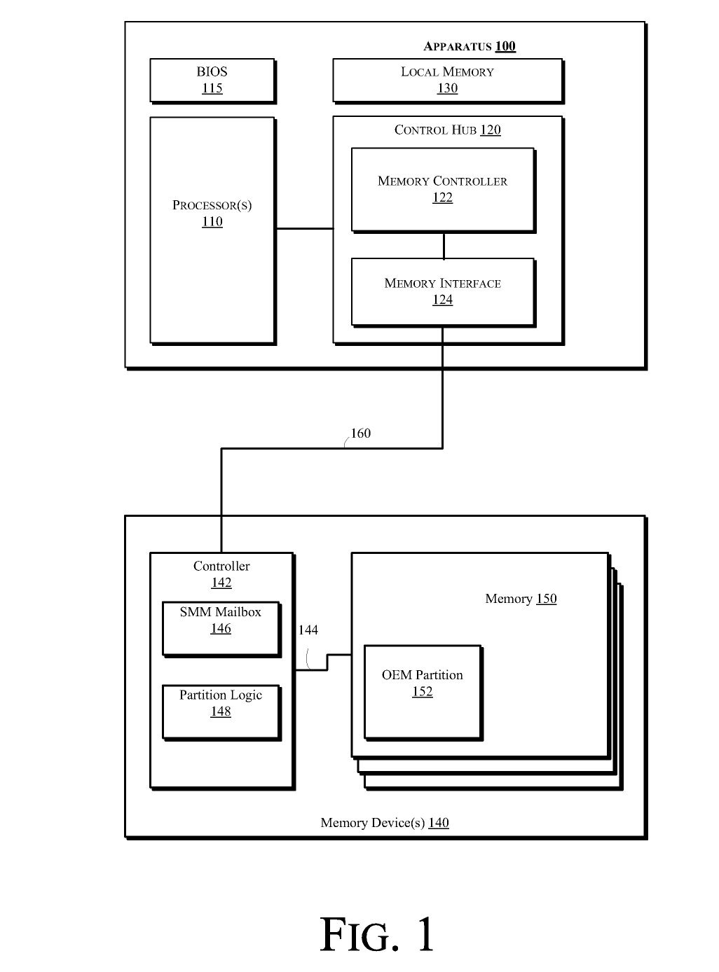

In some examples described herein a controller coupled to memory implements logic which allows authorized users to create a secure memory partition in a non-volatile memory device on an electronic device. The controller implements a system management mode (SMM) mailbox which provides an interface between the controller and configuration utilities available when the host processor device is placed in system management mode. An authorized user, e.g., a component manufacturer, can generate a request to the SMM mailbox through BIOS SMM code to create a partition in the non-volatile memory device. Thereafter, the user can implement read and write operations to memory in the partition via the SMM mailbox. The user can also request to delete the partition through the SMM mailbox. The controller further includes partition logic which, in response to requests from the user, implements operations to create the partition, manage read and write operations, and delete the partition. Specific examples will be described below with reference to FIGS. 1-10.

FIG. 1 is a schematic, block diagram illustration of components of an apparatus in which secure data partitions in nonvolatile memory systems may be implemented accordance with various examples discussed herein. Referring to FIG. 1, in some examples an apparatus 100 which comprise one or more processors 110 coupled to a control hub 120 and a local memory 130. Control hub 120 comprises a memory controller 122 and a memory interface 124. In some examples the control hub 120 may be integrated with the processor(s) 110. A basic input/output system (BIOS) 115 may include logic, e.g., firmware, to identify and initialize various system components and to place the apparatus 100 in a known state during a boot-up process. BIOS 115 may include logic which allows component vendors and/or system vendors to configure various components of the apparatus 100. BIOS 115 also includes logic to place the processors 110 in system management mode (SMM).

Memory interface 124 is coupled to one or more remote memory device(s) 140 by a communication bus 160. In some examples, the communication bus 160 may be implemented as traces on a printed circuit board, a cable with copper wires, a fibre optic cable, a connecting socket, or a combination of the above. Memory device(s) 140 may comprise a controller 142 and memory 150. In various embodiments, at least some of the memory 150 may be implemented using volatile memory, e.g., static random access memory (SRAM), a dynamic random access memory (DRAM), alone or in combination with nonvolatile memory, e.g., phase change memory, NAND (flash) memory, ferroelectric random-access memory (FeRAM), nanowire-based non-volatile memory, memory that incorporates memristor technology, three dimensional (3D) cross point memory such as phase change memory (PCM), spin-transfer torque memory (STT-RAM) or Magnetoresistive Random Access Memory (MRAM). The specific configuration of the memory device(s) 150 in the memory 140 is not critical.

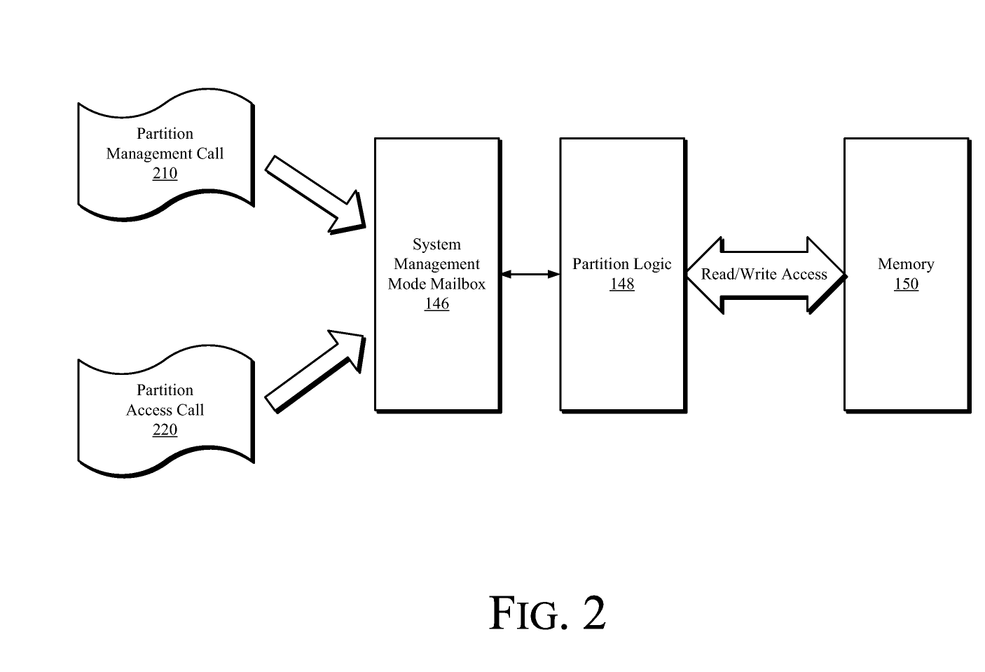

As described briefly above, in some examples described herein, the controller 142 comprises a system management mode (SMM) mailbox 146 which provides an interface between the controller 142 and configuration utilities available when the device is placed in system management mode. As illustrated in FIG. 2, a user such as an original equipment manufacturer (OEM) can generate partition management calls 210 and partition access calls 220 from a configuration utility available in system management mode. The calls 210, 220 are directed to the SMM mailbox 146. Controller 142 further comprises partition logic 148 which performs operations to create a partition, read and write data, and delete a partition in response to requests received in the SMM mailbox 146.

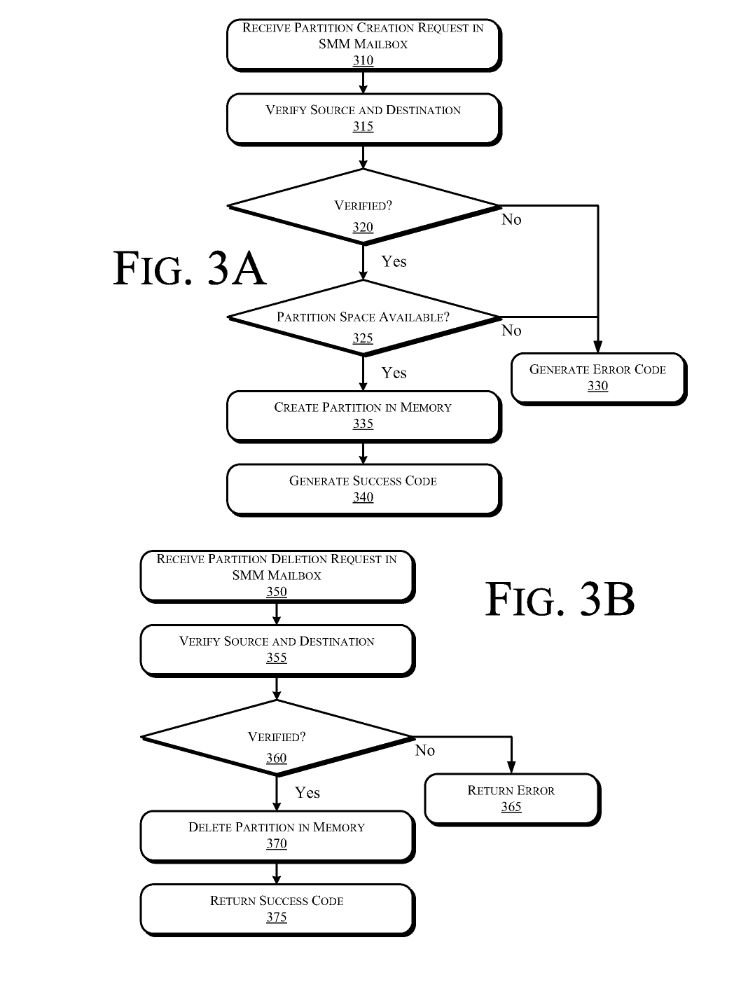

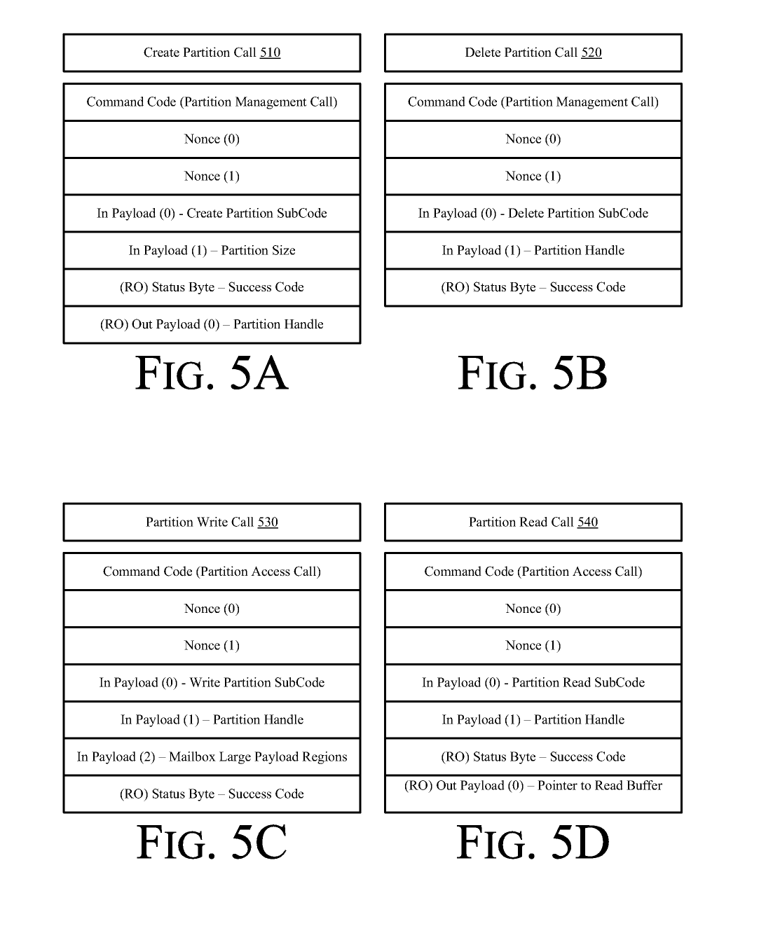

Operations implemented by controller 142 will be described with reference to FIGS. 3A-3B, 4A-4B, 5. A partition creation operation will be explained with reference to FIG. 3A and FIG. 5A. Referring first to FIG. 3A, at operation 310 the memory controller 142 receives a partition creation request in the SMM mailbox 146. By way of example, in operation 310 memory controller 142 receives a request from a user generated via an SMM configuration utility executing on processor 110 or another processor coupled to control hub 120. The partition creation request may identify one or more characteristics such as a requested size of the partition.

At operation 315 the partition logic 148 in controller 142 verifies a source and destination of the partition creation request. For example, at operation 315 the partition logic 148 may confirm that the partition creation request originated from an approved source and was directed to the correct SMM mailbox 146. If, at operation 320 the partition creation request is not verified then control passes to operation 330 and an error code is generated. The error code may be logged in memory and may be returned to the sender.

By contrast, if at operation 320 the partition creation request is verified then control passes to operation 325, at which the partition logic 148 determines whether there is sufficient space available to satisfy the partition creation request. By way of example, the partition logic 148 may enforce a threshold (based on an OEM policy) on the amount of memory which may be dedicated to a specific partition or to multiple partitions. The threshold may be static or dynamic and may be established by a manufacturer or other vendor. If, at operation 325, there is insufficient memory available to satisfy the partition creation request then control passes to operation 330 and an error code is generated. The error code may be logged in memory and may be returned to the sender.

By contrast, if at operation 325 there is sufficient memory available to accommodate the partition creation request then control passes to operation 335 and the partition logic 148 creates a partition in memory 150. At operation 340 the partition logic 148 generates a success code. The success code may be logged in memory and may be returned to the sender.

FIG. 5A is a schematic illustration of an interface format for a create partition call. Referring to FIG. 5A, in some examples the interface 510 comprises a command code, e.g., a partition management call, one or more nonces, a create partition subcode, a partition size, a success code, and a partition handle.

A partition deletion operation will be explained with reference to FIG. 3B and FIG. 5B. Referring first to FIG. 3B, at operation 350 the memory controller 142 receives a partition deletion request in the SMM mailbox 146. By way of example, in operation 350, memory controller 142 receives a request from a user generated via an SMM configuration utility executing on processor 110 or another processor coupled to control hub 120. The partition deletion request may identify one or more characteristics such as the handle of the partition.

At operation 355 the partition logic 148 in controller 142 verifies a source and destination of the partition deletion request. For example, at operation 355 the partition logic 148 may confirm that the partition deletion request originated from an approved source and was directed to the correct SMM mailbox 146. If, at operation 360 the partition deletion request is not verified then control passes to operation 365 and an error code is generated. The error code may be logged in memory and may be returned to the sender.

By contrast, if at operation 360 the partition deletion request is verified then control passes to operation 370 and the partition logic 148 deletes the partition in memory 150. At operation 375 the partition logic 148 generates a success code. The success code may be logged in memory and may be returned to the sender.

FIG. 5B is a schematic illustration of an interface format for a create partition call. Referring to FIG. 5B, in some examples the interface 510 comprises a command code, e.g., a partition management call, one or more nonces, a delete partition subcode, a partition handle, and a success code. As used herein, the term nonce refers to an arbitrary or pseudorandom number used in cryptographic communication.

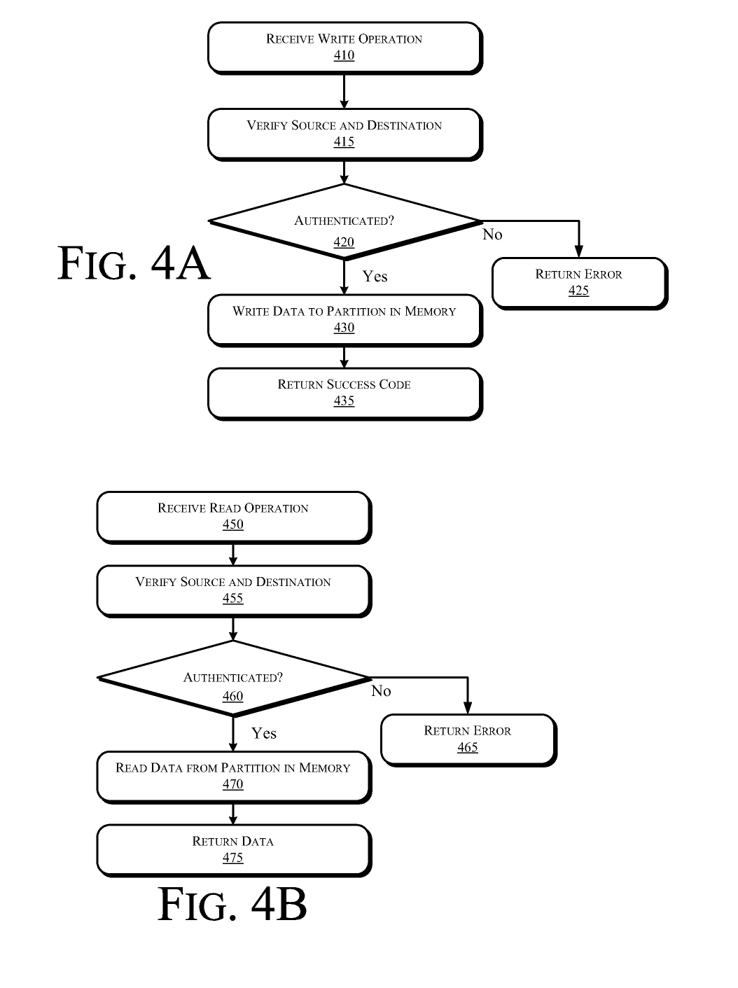

A partition write operation will be explained with reference to FIG. 4A and FIG. 5C. Referring first to FIG. 4A, at operation 410 the memory controller 142 receives a partition write operation in the SMM mailbox 146. By way of example, in operation 410 memory controller 142 receives a write operation from a user generated via an SMM configuration utility executing on processor 110 or another processor coupled to control hub 120. The partition write operation may identify one or more characteristics such as the handle of the partition.

At operation 415 the partition logic 148 in controller 142 verifies a source and destination of the partition write operation. For example, at operation 415 the partition logic 148 may confirm that the partition write request originated from an approved source and was directed to the correct SMM mailbox 146. If, at operation 420 the partition write operation is not verified then control passes to operation 425 and an error code is generated. The error code may be logged in memory and may be returned to the sender. In some examples a nonce sent from authorized user in SMM code can prove to partition memory controller the origin of the request to be used for authentication of the request. Alternatively, hardware signals from memory interface unit 124 to controller 142 travelling through system fabric 160 may be used to prove authenticity of the user request to controller 142 from processor system 110.

By contrast, if at operation 420 the partition write operation is verified then control passes to operation 430 and the partition logic 148 executes a write operation to the partition in memory 150. At operation 435 the partition creation logic generates a success code. The success code may be logged in memory and may be returned to the sender.

FIG. 5C is a schematic illustration of an interface format for a partition write call. Referring to FIG. 5C, in some examples the interface 530 comprises a command code, e.g., a partition access call, one or more nonces, a partition write subcode, a partition handle, a mailbox large payload regions identifier, and a success code. In some examples, large payloads of secure data can be managed by memory controller by allocating large memory partitions. The controller may also include hardware logic like range registers that could speed up read and access speeds of the data partition.

A partition read operation will be explained with reference to FIG. 4B and FIG. 5D. Referring first to FIG. 4B, at operation 450 the memory controller 142 receives a partition read operation in the SMM mailbox 146. By way of example, in operation 450 memory controller 142 receives a read operation from a user generated via an SMM configuration utility executing on processor 110 or another processor coupled to control hub 120. The partition read operation may identify one or more characteristics such as the handle of the partition.

At operation 455 the partition logic 148 in controller 142 verifies a source and destination of the partition read operation. For example, at operation 415 the partition logic 148 may confirm that the partition read request originated from an approved source and was directed to the correct SMM mailbox 146. If, at operation 460 the partition read operation is not verified then control passes to operation 465 and an error code is generated. The error code may be logged in memory and may be returned to the sender.

By contrast, if at operation 460 the partition read operation is verified then control passes to operation 470 and the partition logic 148 executes a read operation to the partition in memory 150. At operation 475 the partition creation logic 148 returns the data from the read operation to the sender.

FIG. 5D is a schematic illustration of an interface format for a partition write call. Referring to FIG. 5D, in some examples the interface 540 comprises a command code, e.g., a partition access call, one or more nonces, a partition read subcode, a partition handle, a success code, and a pointer to a read buffer.

Thus, the structure and operations described herein enable a controller 142 to implement secure data partition operations on a memory device. More particularly, the structure and operations described herein enable controller 142 to create a partition in a memory device, securely execute read and write operations to the partition, and to delete the partition. In some examples, the system management code in processor 100 may implement additional data encryption mechanisms for increased security of the partition data.

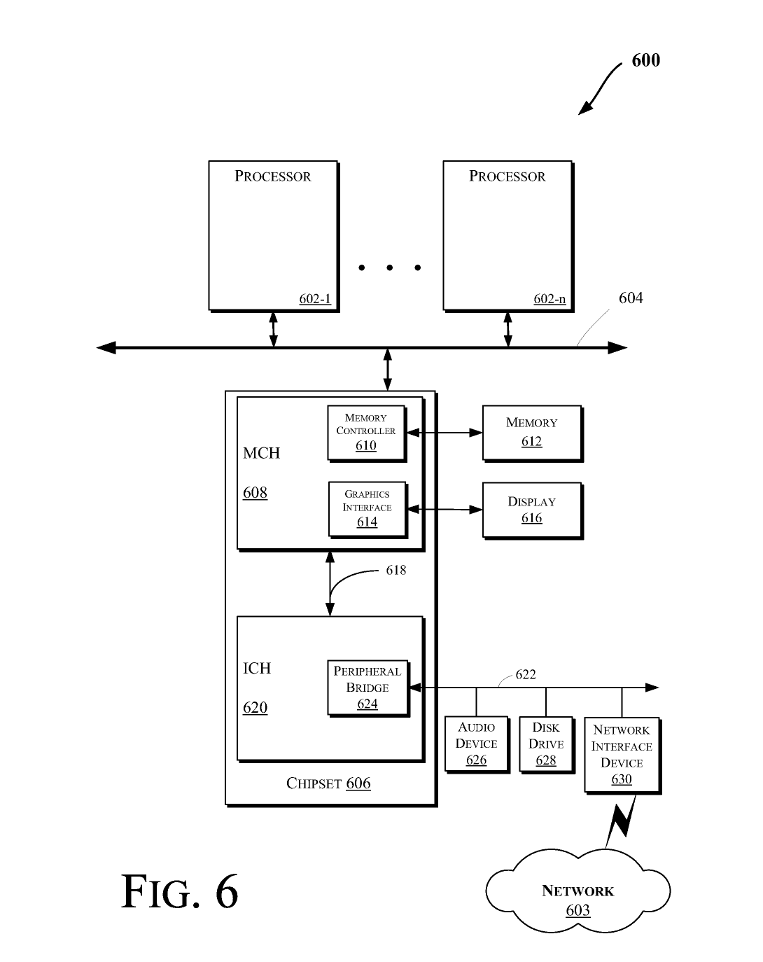

As described above, in some examples the electronic device may be embodied as a computer system. FIG. 6 illustrates a block diagram of a computing system 600 in accordance with an example. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

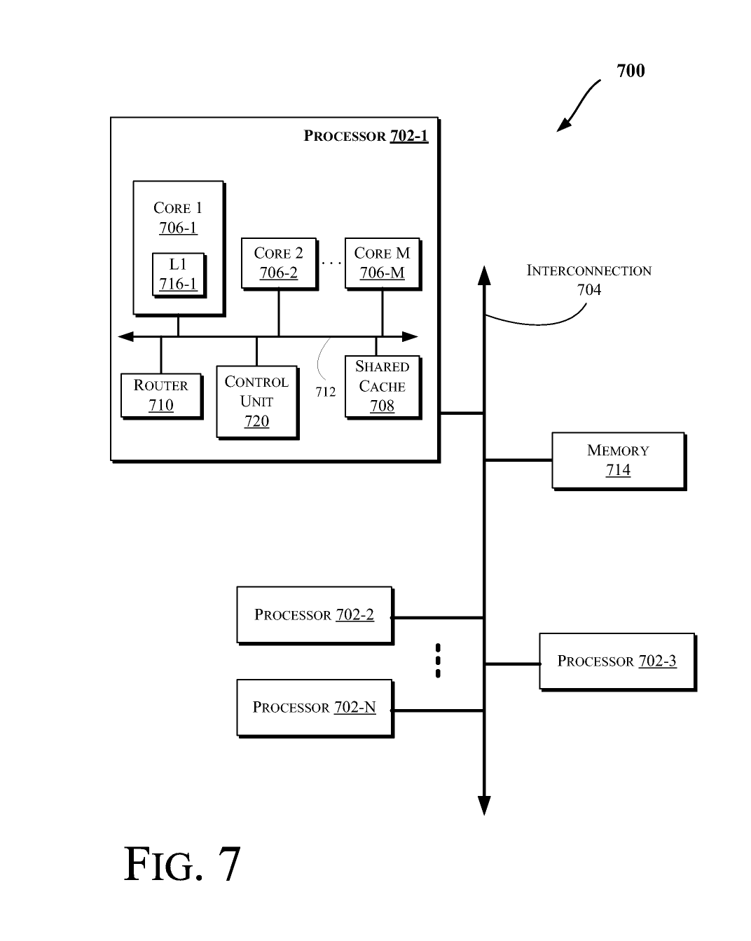

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

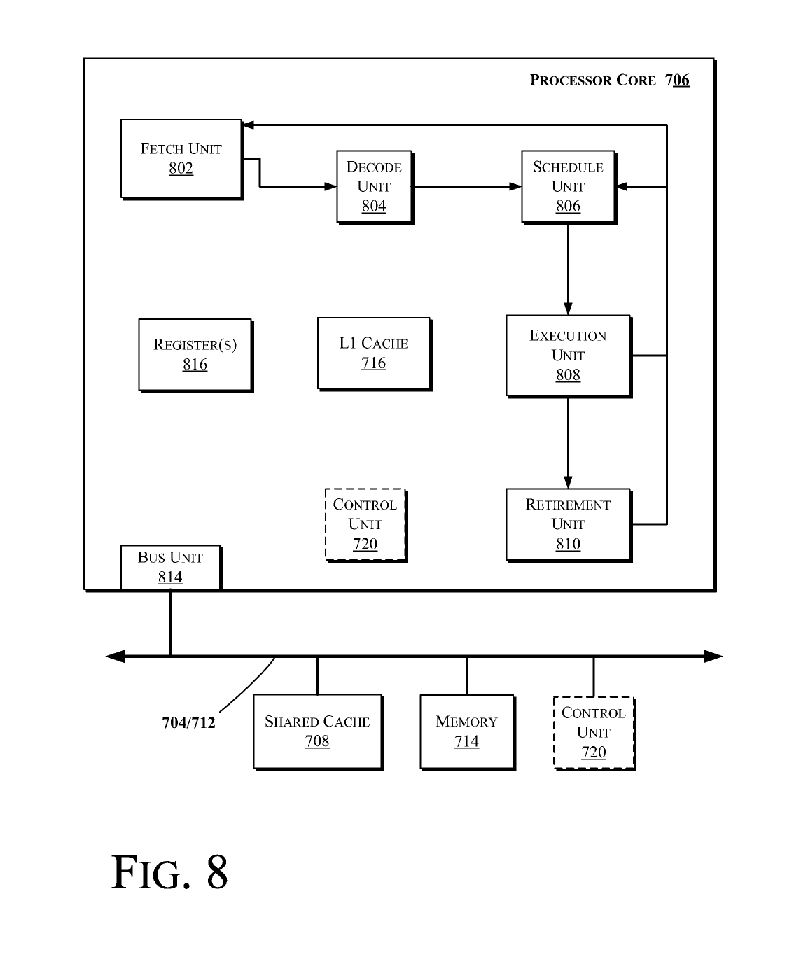

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

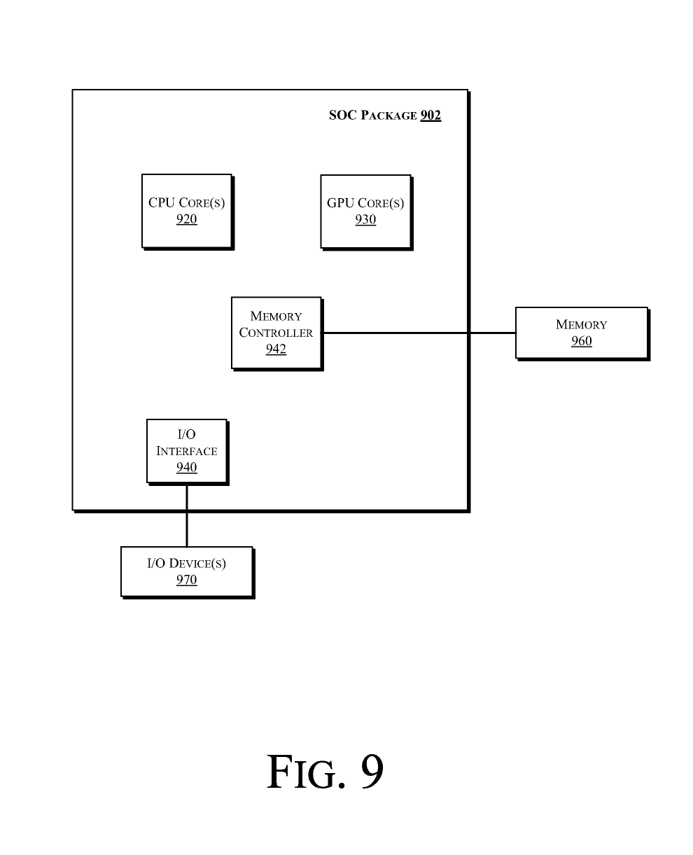

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

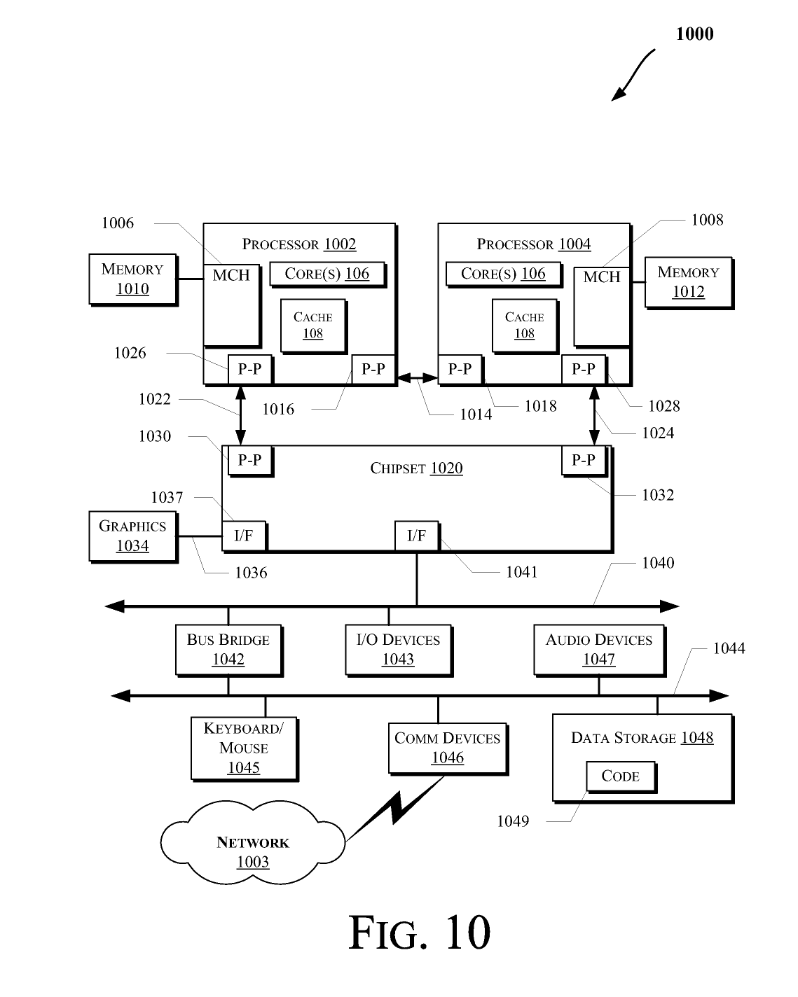

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1002 and 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a point-to-point PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 803), audio I/O device, and/or a data storage device 1048. The data storage device 1048 (which may be a hard disk drive or a NAND flash based solid state drive) may store code 1049 that may be executed by the processors 1002 and/or 1004.

The following examples pertain to further examples.

Example 1 is a controller comprising logic to receive, in a system management mode mailbox, a memory partition creation request from a system management mode interface, wherein the memory partition creation request comprises at least one characteristic of a memory partition, authenticate the partition creation request, and create a memory partition in a memory coupled to the controller in accordance with the at least one characteristic.

In Example 2, the subject matter of Example 1 can optionally include logic to verify a source of the partition creation request, and verify a destination of the partition creation request.

In Example 3, the subject matter of any one of Examples 1-2 can optionally include an arrangement in which the logic to authenticate the partition creation request comprises logic to verify a source of the partition creation request, and verify a destination of the partition creation request.

In Example 4, the subject matter of any one of Examples 1-3 can optionally include logic to generate an error code in response to an authentication failure or a determination that the partition size is not available for allocation to a partition.

In Example 5, the subject matter of any one of Examples 1-4 can optionally include logic to generate a success code after the memory partition is created.

In Example 6, the subject matter of any one of Examples 1-5 can optionally include logic to receive, in a system management mode mailbox, a write request to the memory partition from a system management mode interface, authenticate the write request, and write data into the memory partition.

In Example 7, the subject matter of any one of Examples 1-6 can optionally include logic to receive, in a system management mode mailbox, a read request to the memory partition from a system management mode interface, authenticate the read request, and read data from the memory partition.

In Example 8, the subject matter of any one of Examples 1-7 can optionally include logic to receive, in a system management mode mailbox, a delete request to delete the memory partition from a system management mode interface, authenticate the delete request, and delete the memory partition.

Example 9 is an apparatus comprising a non-volatile memory and a controller comprising logic to receive, in a system management mode mailbox, a memory partition creation request from a system management mode interface, wherein the memory partition creation request comprises at least one characteristic of a memory partition, authenticate the partition creation request, and create a memory partition in a memory coupled to the controller in accordance with the at least one characteristic.

In Example 10, the subject matter of Example 9 can optionally include logic to verify a source of the partition creation request, and verify a destination of the partition creation request.

In Example 11, the subject matter of any one of Examples 9-10 can optionally include an arrangement in which the logic to authenticate the partition creation request comprises logic to verify a source of the partition creation request, and verify a destination of the partition creation request.

In Example 12, the subject matter of any one of Examples 9-11 can optionally include logic to generate an error code in response to an authentication failure or a determination that the partition size is not available for allocation to a partition.

In Example 13, the subject matter of any one of Examples 9-12 can optionally include logic to generate a success code after the memory partition is created.

In Example 14, the subject matter of any one of Examples 9-13 can optionally include logic to receive, in a system management mode mailbox, a write request to the memory partition from a system management mode interface, authenticate the write request, and write data into the memory partition.

In Example 15, the subject matter of any one of Examples 9-14 can optionally include logic to receive, in a system management mode mailbox, a read request to the memory partition from a system management mode interface, authenticate the read request, and read data from the memory partition.

In Example 16, the subject matter of any one of Examples 9-15 can optionally include logic to receive, in a system management mode mailbox, a delete request to delete the memory partition from a system management mode interface, authenticate the delete request, and delete the memory partition.

Example 17 is an electronic device comprising logic to receive, in a system management mode mailbox, a memory partition creation request from a system management mode interface, wherein the memory partition creation request comprises at least one characteristic of a memory partition, authenticate the partition creation request, and create a memory partition in a memory coupled to the controller in accordance with the at least one characteristic.

In Example 18, the subject matter of Example 17 can optionally include logic to verify a source of the partition creation request, and verify a destination of the partition creation request.

In Example 19, the subject matter of any one of Examples 17-18 can optionally include an arrangement in which the logic to authenticate the partition creation request comprises logic to verify a source of the partition creation request, and verify a destination of the partition creation request.

In Example 20, the subject matter of any one of Examples 17-19 can optionally include logic to generate an error code in response to an authentication failure or a determination that the partition size is not available for allocation to a partition.

In Example 21, the subject matter of any one of Examples 17-20 can optionally include logic to generate a success code after the memory partition is created.

In Example 22, the subject matter of any one of Examples 17-21 can optionally include logic to receive, in a system management mode mailbox, a write request to the memory partition from a system management mode interface, authenticate the write request, and write data into the memory partition.

In Example 23, the subject matter of any one of Examples 17-22 can optionally include logic to receive, in a system management mode mailbox, a read request to the memory partition from a system management mode interface, authenticate the read request, and read data from the memory partition.

In Example 24, the subject matter of any one of Examples 17-23 can optionally include logic to receive, in a system management mode mailbox, a delete request to delete the memory partition from a system management mode interface, authenticate the delete request, and delete the memory partition.

In various examples, the operations discussed herein, e.g., with reference to FIGS. 1-10, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein.

Reference in the specification to “one example” or “an example” means that a particular feature, structure, or characteristic described in connection with the example may be included in at least an implementation. The appearances of the phrase “in one example” in various places in the specification may or may not be all referring to the same example.

Also, in the description and claims, the terms “coupled” and “connected,” along with their derivatives, may be used. In some examples, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

1. A controller comprising logic to:
receive, in a system management mode mailbox, a memory partition creation request from a system management mode interface, wherein the memory partition creation request comprises at least one characteristic of a memory partition;
authenticate the partition creation request; and
create a memory partition in a memory coupled to the controller in accordance with the at least one characteristic.

2. The controller of claim 1, wherein the logic to authenticate the partition creation request comprises logic to:
verify a source of the partition creation request; and
verify a destination of the partition creation request.

3. The controller of claim 1, wherein the partition creation request specifies a partition size for the memory partition, and further comprising logic to:
determine whether the partition size is available for allocation to a partition.

4. The controller of claim 3, further comprising logic to
generate an error code in response to an authentication failure or a determination that the partition size is not available for allocation to a partition.

5. The controller of claim 4, further comprising logic to:
generate a success code after the memory partition is created.

6. The controller of claim 1, further comprising logic to:
receive, in a system management mode mailbox, a write request to the memory partition from a system management mode interface;
authenticate the write request; and
write data into the memory partition.

7. The controller of claim 1, further comprising logic to:
receive, in a system management mode mailbox, a read request to the memory partition from a system management mode interface;
authenticate the read request; and
read data from the memory partition.

8. The controller of claim 1, further comprising logic to:
receive, in a system management mode mailbox, a delete request to delete the memory partition from a system management mode interface;
authenticate the delete request; and
delete the memory partition.

9. An apparatus, comprising:
a non-volatile memory; and
a controller comprising logic to:
receive, in a system management mode mailbox, a memory partition creation request from a system management mode interface, wherein the memory partition creation request comprises at least one characteristic of a memory partition;
authenticate the partition creation request; and
create a memory partition in a memory coupled to the controller in accordance with the at least one characteristic.

10. The apparatus of claim 9, wherein the logic to authenticate the partition creation request comprises logic to:
verify a source of the partition creation request; and
verify a destination of the partition creation request.

11. The apparatus of claim 9, wherein the partition creation request specifies a partition size for the memory partition, and further comprising logic to:
determine whether the partition size is available for allocation to a partition.

12. The apparatus of claim 9, further comprising logic to
generate an error code in response to an authentication failure or a determination that the partition size is not available for allocation to a partition.

13. The apparatus of claim 12, further comprising logic to:
generate a success code after the memory partition is created.

14. The apparatus of claim 9, further comprising logic to:
receive, in a system management mode mailbox, a write request to the memory partition from a system management mode interface;
authenticate the write request; and
write data into the memory partition.

15. The apparatus of claim 9, further comprising logic to:
receive, in a system management mode mailbox, a read request to the memory partition from a system management mode interface;
authenticate the read request; and
read data from the memory partition.

16. The apparatus of claim 9, further comprising logic to:
receive, in a system management mode mailbox, a delete request to delete the memory partition from a system management mode interface;
authenticate the delete request; and
delete the memory partition.

17. An electronic device, comprising:
receive, in a system management mode mailbox, a memory partition creation request from a system management mode interface, wherein the memory partition creation request comprises at least one characteristic of a memory partition;
authenticate the partition creation request; and
create a memory partition in a memory coupled to the controller in accordance with the at least one characteristic.

18. The electronic device of claim 17, wherein the logic to authenticate the partition creation request comprises logic to:
verify a source of the partition creation request; and
verify a destination of the partition creation request.

19. The electronic device of claim 17, wherein the partition creation request specifies a partition size for the memory partition, and further comprising logic to:
determine whether the partition size is available for allocation to a partition.

20. The electronic device of claim 17, further comprising logic to
generate an error code in response to an authentication failure or a determination that the partition size is not available for allocation to a partition.

21. The electronic device of claim 20 further comprising logic to:
generate a success code after the memory partition is created.

22. The electronic device of claim 17, further comprising logic to:
receive, in a system management mode mailbox, a write request to the memory partition from a system management mode interface;
authenticate the write request; and
write data into the memory partition.

23. The electronic device of claim 17, further comprising logic to:
receive, in a system management mode mailbox, a read request to the memory partition from a system management mode interface;
authenticate the read request; and
read data from the memory partition.

24. The electronic device of claim 17, further comprising logic to:
receive, in a system management mode mailbox, a delete request to delete the memory partition from a system management mode interface;
authenticate the delete request; and
delete the memory partition.
